(19) United States
(12) Patent Application Publication
(10) Pub. No.: US 2007/0257977 A1
(43) Pub. Date: Nov. 8, 2007

(54) SECURITY ENHANCED PRINT MEDIA WITH COPY PROTECTION

(75) Inventors: David Michael Wicker, Dansville, NY (US); Michael Scott Caton, Oakfield, NY (US)

Correspondence Address: Stephen B. Salai, Esq.;Harter, Secrest & Emery LLP, 1600 Bausch & Lomb Place, Rochester, NY, 14604-2711, US

(73) Assignee: DOCUMENT SECURITY SYSTEMS, INC., Rochester, NY (US)

(21) Appl. No.: 11/744,840

(22) Filed: May 5, 2007

Related U.S. Application Data
(60) Provisional application No. 60/797,686, filed on May 5, 2006.

(51) Int. Cl. B41J 2/01

(52) U.S. Cl. 347/107

(57) ABSTRACT

Copy protections are incorporated into print media by embedding a plurality of latent images formed by different line-screen patterns within a visually integrated setting formed by another different line-screen pattern. The different line-screen patterns of the latent images have line frequencies empirically selected so that upon reproduction at least one of the latent images is rendered more readily discernable to the unaided eye. A masking design formed by another line-screen pattern overlies both the latent images and the visually integrated setting.

### CROSS-REFERENCE TO RELATED APPLICATIONS

This application is a nonprovisional of U.S. Provisional Application No. 60/797,686 filed on May 5, 2006, which priority application is hereby incorporated by reference.

### TECHNICAL FIELD

This invention relates generally to protection methods and products for print media, and more particularly to methods and products for printing and obtaining original print media that can be readily differentiated from copies.

### BACKGROUND OF THE INVENTION

Secure documents and other print media for commercial, personal, or official use have been produced in the past by letterpress, offset, and intaglio printing processes, including such processes adapted for embedding hidden information or security images. Document embedded security features deter counterfeiting of valuable papers, important records, and financial instruments such as checks, currency, so that original documents can be verified and unauthorized copies of these documents can be readily distinguished from the originals.

The printing of such original documents can be carried out either in black-and-white (B&W) or in color; and if in color, in spot color, colored backgrounds, or multicolor printing. Multiple colors are often preferred for original documents to enhance aesthetic value and ease of recognition, as well as to protect the documents from copying by conventional means. Printing processes for printing valuable originals, whether in B&W or in color, include intaglio (e.g., gravure), letterpress, and offset printing, among others. These and the other processes mentioned in this application are very well known in the art and will not be discussed in great detail.

One approach to deterring counterfeiting or other forms of unauthorized reproduction of originals includes embedding “latent images” containing covert information or other indicia (e.g., security codes, graphics, or information such as amounts of money and bank account numbers) within the original documents. The latent images, which are hidden within a visually integrated setting, are intended to be practically invisible to the naked eye under normal viewing conditions. Such settings for hiding the latent images range from simple background tints to the remainders of composite images within which the latent images are hidden. However, the latent images are otherwise distinguishable through the use of a visual aid, such as a magnifier or reader. Upon reproduction, such as by scanning or copying of the originals, the latent images can be arranged to either disappear or become more pronounced. That is, either the absence of the latent image or the visible presence of the latent image in a copy can be construed as an indication of a non-original document.

The latent images can be produced by embedding one line-screen pattern within another line-screen pattern. Each of the line-screen patterns can be formed by an array of print elements, such as dots, dashes, line segments, or other elemental shapes, in an arrangement of systematically spaced lines. The two line-screen patterns can be formed so as to be indistinguishable from one another to the naked eye, but can differ in some respect that can be optically exploited for viewing the latent image. For example, the two line-screen patterns can be printed in the same color and at the same print density but can differ in orientation or line frequency.

A first line-screen pattern can be printed in defined areas having one or more shapes for forming the latent image. A second line-screen pattern can be printed throughout an adjoining or an enlarged area forming a visually integrated setting, such as a complementary background or a remaining portion of a composite image. Each of the two line patterns can be formed by a plurality of line patterns in different colors so long as the multiple line patterns that form the latent image match the color and overall appearance of the one or more line patterns that form the visually integrated setting.

Other developments for purposes of providing document protection are disclosed in the patent literature, as for example, in U.S. Pat. No. 5,018,767 issued May 28, 1991, U.S. Pat. No. 3,675,948 issued Jul. 11, 1972, and U.S. Pat. No. 4,143,967 issued Mar. 13, 1979, all to Ralph C. Wicker and 5,735,547 issued Apr. 7, 1998 to Frederic Morelle and Ralph Wicker. All of these patents, which are hereby incorporated by reference, disclose various means for providing methods and products to enable copies of documents to be distinguished from the originals, as for example, by a “large dot-small dot pattern”, a “close line-spaced pattern”, and images or indicia which are screen printed at minutely varied spaces and/or angles on the originals and are intended to produce a highly visible moiré pattern effect on the unauthorized copies. In this specification, the words “print”, “printed,” and “printing” are used to refer to the making of an original document by any of a number of known printing means, including transferring images from one source to another, typically a paper substrate, using a transfer agent such as ink or toner. The words “copy” and “copying” to refer to making copies from an original printed document.

Improvements in copying, including color copying and desktop scanning, provide increasingly sophisticated tools for counterfeiters to succeed in overcoming known document security protections. An acknowledged goal of copier and computer scanner-printer technologies has been to obtain copies “as good as an original.” Even desktop computers have become sophisticated in color reproduction, including color matching of copies to color standards such as the PANTONE® Color Matching System.

Many of the document protection methods and products currently in use were developed before this very significant improvement in copier, scanner-printer, and other digital reproduction technologies, and are not as effective in distinguishing unauthorized copies from originals. This is especially true of color copiers with a “photo” setting that intentionally copies a document in an “unsharp” focus so as to give the effect of a continuous tone image, the effect of which can be to defeat the precise line variation between the copier scanner and the security pattern on the document original.

Most copying and scanning machines currently in use perform a geometric horizontal or vertical scan of documents to produce the image of the document. In order to accurately scan a colored document, such as a poster, for reproduction, several scans may be taken of the document at several angles, such as 90 degrees, 45 degrees, and 0 degrees. Then, the images produced from the scan may be provided to a software program, such as PHOTOSHOP, and color separated to form separate images in each of the primary printing colors, e.g. cyan, yellow, magenta, and black. Once the document has been color separated, a skilled artisan can readily identify defects in each color image separately, allowing them to defeat most security markings on the document, such as water markings and distortion producing patterns. After correcting the defects in the separate color images, the artisan can recombine the color images to produce a near identical copy of the original document.

Thus, it has become imperative for purposes of document security that further improvements in the area of document protection for documents be found, especially where there is a need to prevent copying or duplicating of valuable originals by readily distinguishing the copies from the originals.

### SUMMARY OF THE INVENTION

Among the objects of this invention is the further development of document security technologies to thwart undetected copying of original documents and other print media on increasingly sophisticated digital reproduction technologies. The invention among certain of its embodiments features the printing of a plurality of latent images with line-screen patterns having different line frequencies matched to different digital reproduction technologies to assure reproduction in some form. The latent images are embedded within a visually integrated setting formed by line-screen pattern having a line frequency that is matched to the different digital reproduction technologies to avoid a similar form of reproduction.

For example, the line-screen patterns of the latent images can be arranged with line frequencies that are well within the resolving capability of the matched reproduction technologies or that interfere with the reproduction technologies so as to produce altered imaging such as moiré fringes. The line-screen patterns of the visually integrated settings can be arranged with line frequencies that exceed the resolving capability of the matched reproduction technologies or that reproduce differently than the lower line frequencies of the latent images.

One version of the invention as a security enhanced print medium includes a print substrate and a plurality of latent images formed by a plurality of different line-screen patterns printed on distinct areas of the print substrate within a visually integrated setting formed by another different line-screen pattern printed on adjoining areas of the print substrate. The different line-screen patterns of the latent images and the visually integrated setting match in color and print density so that the latent images are not readily discernable to an unaided eye. The different line-screen patterns of the latent images have a line frequency less than a line frequency of the line-screen pattern of the visually integrated setting. The different line-screen patterns of the latent images also have line frequencies differing from one another so that upon reproduction of the print medium through a sensor array, at least one of the latent images is rendered readily discernable to the unaided eye.

Ordinarily, the print substrate has a rectangular form with orthogonal axes extending along adjacent sides of the print substrate. The different line-screen patterns of the latent images are preferably aligned with at least one of the orthogonal axes. The line-screen pattern of the visually integrated setting is preferably inclined at an acute angle to both orthogonal axes. An inclination of around 45 degrees is preferred. The different line-screen patterns of the latent images are preferably aligned with just one of the orthogonal axes.

The line-screen patterns of the latent images have preferred line frequencies below 120 lines per inch, and the line-screen pattern of the visually integrated setting has a preferred line frequency above 120 lines per inch. For example, the line-screen patterns of the latent images can include one line frequency of approximately 75 lines per inch and another line frequency of approximately 95 lines per inch to exploit the reproductive characteristics of known digital reproduction technologies for preserving, darkening, distorting, or otherwise visually reacting with the line-screen patterns of the latent images. The line-screen pattern of the visually integrated setting can have a line frequency of approximately 180 lines per inch so as to reproduce differently, e.g., optically shift, with the same digital reproduction technologies. Other the latent image line-screen patterns can have line frequencies of approximately 65 lines per inch or 90 lines per inch for similar reasons. At the tested line-frequencies, the matching print densities of the latent images and the visually integrated settings are preferably between 5 percent and 25 percent.

Particularly for the purpose of obscuring the lower line frequencies among the line-screen patterns of the latent images, a masking design can be printed in positions that overlap both the latent images and the visually integrated setting. A line-screen pattern of the masking design overlaps with the line-screen patterns of both the latent images and the visually integrated setting over common areas of the print substrate. Print elements of the masking design line-screen pattern can be printed in between, around, or on intact line structures of the line-screen patterns of the latent images and the visually integrated setting.

Preferably, the line-screen pattern of the masking design is oriented at an angle that differs from angular orientations of the line-screen patterns of both the latent images and the visually integrated setting. In addition, the masking design can be evenly spatially distributed over the printed areas of the print substrate so as to have a balanced effect throughout. The latent images can also be evenly spatially distributed over the printed areas of the print substrate for the same purpose. The even distributions can be random or ordered arrangements.

The line-screen patterns of the latent image, the visually integrated setting, and the masking design are all formed by arrays of print elements in arrangements of systematically spaced lines. The print elements that form the masking design line-screen pattern can differ from the print elements that form the visually integrated setting line-screen pattern. The print elements that form the masking design line-screen pattern can also differ from the print elements that form the latent image line-screen patterns. For example, the print elements that form the masking design line-screen pattern can be spaced apart along the systematically spaced lines of the line-screen pattern, or the print elements that form the masking design line-screen pattern can be a different color than the print elements that form the line-screen patterns of the latent images and the visually integrated setting.

Another version of the invention as a method of making a security enhanced print medium includes printing a plurality of latent images within a visually integrated setting on a print substrate using line-screen patterns that match in color and print density so that the latent images are not readily distinguishable from the visually integrated setting to the naked eye. The latent images are arranged with line-screen patterns having line frequencies that differ from each other and from a line frequency of the line-screen pattern of the visually integrated setting. Each of the different line frequencies of the latent image line-screen patterns are set to react preferentially with a different digital reproduction technology for relatively increasing the latent images in tone with respect to the visually integrated setting upon reproduction by the digital reproduction technologies.

The different line frequencies of the latent image line-screen patterns are preferably approximately 75 lines per inch and 95 lines per inch. Other preferred line frequencies of the latent image line-screen patterns include line frequencies of 65 lines per inch and 90 lines per inch. The line frequency of the visually integrated setting line-screen pattern is preferably set to react with one or more of the different digital reproduction technologies so that the visually integrated setting reduces in tone upon digital reproduction. The line frequency of the visually integrated setting is preferably approximately 180 lines per inch.

The line-screen patterns of the latent images are preferably oriented orthogonal to one or more edges of the print substrate. The line-screen pattern of the visually integrated setting is preferably oriented at an acute angle to the one or more edges of the print substrate. More preferably, the line-screen patterns of the latent images are oriented in a common direction.

A masking design can be printed on the print substrate with a line-screen pattern that overlaps with the line-screen patterns of both the latent images and the visually integrated setting. The line-screen pattern of the masking design is preferably oriented at an angle that differs from angular orientations of the line-screen patterns of both the latent images and the visually integrated setting.

The line-screen patterns are preferably printed as arrays of print elements in arrangements of systematically spaced lines. The print elements of the masking design can differ from the print elements of both the latent images and the visually integrated setting. For example, the print elements that form the masking design line-screen pattern can be printed in positions that are spaced apart along the systematically spaced lines of the line-screen pattern, or the print elements that form the masking design line-screen pattern can be printed in a different color than the print elements of both the latent images and the visually integrated setting.

Another version of the invention as a camouflaged security enhanced print medium includes a print substrate and a plurality of latent images formed by a plurality of different line-screen patterns printed on distinct areas of the print substrate within a visually integrated setting formed by another different line-screen pattern printed on adjoining areas of the print substrate. The different line-screen patterns of the latent images and the visually integrated setting match in color and print density so that the latent images are not readily discernable to an unaided eye. A masking design formed by a line-screen pattern printed on both the distinct areas of the print substrate and the adjoining areas of the print substrate further obscures differences between the latent images and the visually integrated setting.

The line-screen pattern of the masking design can be oriented at an angle that differs from angular orientations of the line-screen patterns of both the latent images and the visually integrated setting. However, the masking design is preferably evenly spatially distributed over the printed areas of the print substrate. The latent images are also preferably evenly spatially distributed over the printed areas of the print substrate.

The print elements that form the masking design line-screen pattern can differ from the print elements that form the visually integrated setting line-screen pattern. For example, the print elements that form the masking design line-screen pattern can be spaced apart along the systematically spaced lines of the line-screen pattern, or the print elements that form the masking design line-screen pattern can be a different color than the print elements that form the line-screen patterns of the latent images and the visually integrated setting.

The different line-screen patterns of the latent images can have a line frequency less than a line frequency of the line-screen pattern of the visually integrated setting, and the different line-screen patterns of the latent images can also have line frequencies differing from one another so that upon reproduction of the print medium through a digital reproduction technology, at least one of the latent images is rendered more discernable to the unaided eye. The line-screen pattern of the masking design preferably has a line frequency at least approximately as high as the line frequency of the visually integrated setting line-screen pattern so that upon digital reproduction both the masking pattern and the visually integrated setting relative fade for rendering the latent images more readily visible.

### BRIEF DESCRIPTION OF THE DRAWINGS

FIG. 1 is a front view of a stock paper document incorporating latent images formed by different line-screen patterns within a visually integrated setting formed by another line-screen pattern. The line frequencies of the line-screen patterns are greatly reduced for purposes of illustrations so that the pattern lines are visible and the latent images are distinguishable from the visually integrated setting.

FIG. 2 is a similar front view of a digitally reproduced copy of the stock paper document of FIG. 1, showing a differential visual effect between the latent images and the visually integrated setting.

FIG. 3 is a similar front view of a stock paper document modified by the incorporation of a masking pattern that overlaps the latent images and the visually integrated setting with another line-screen pattern.

FIG. 4 is an enlarged view of a similar stock paper document showing the masking pattern overlapping partial characters of the latent images and the visually integrated setting.

FIG. 5 is a similarly enlarged view of another stock paper document in which the masking pattern comprises characters filled by another line-screen pattern.

### DETAILED DESCRIPTION OF THE INVENTION

Most copying and scanning equipment, referred to more generally as digital reproduction technologies, scans documents in directions orthogonal to a sensor array, such as a charge coupled device (CCD) array. These devices include regularly ordered arrays or other sampling or processing frequencies that can interfere with line-screen patterns on the scanned documents having certain line frequencies. Such interference prevents the line-screen patterns from being reproduced accurately. For example, moiré fringes can appear mixed with or in place of the line-screen patterns. Typical digital scanning devices, including copiers, have interference frequencies of more than one first order moiré at line frequencies of 65, 80, 95, and 105 lines per inch.

In addition to exploiting moiré distortions or omissions, the invention is further directed to combinations of line-screen patterns that particularly favor the differential treatment of line-screen patterns over different ranges of line frequencies.

Through iterative trials, it has been found that there is a threshold of tolerance in the onboard software/firmware that processes data gathered by the CCD (charge-coupled device) arrays of scanners and copiers. This threshold is apparent when line-screen patterns containing lines, dots or spots of two or more line frequencies is scanned. These frequencies are considered either high or low frequencies (as perceived by the CCD array and the processing firmware/software). The CCD array records the high or low printed frequencies or spaces between the printed images. When this information is relayed to the processing software/firmware, the various line frequencies that comprise the artwork are assigned to travel through either high pass or low pass filters. In our testing, we have found that the line frequencies assigned to the high pass filters are approximately 120 lines per inch and above, while the line frequencies assigned to the low pass filters are approximately 120 lines per inch and below.

To create a secure document in accordance with this understanding, the print medium should contain hidden (latent) images composed of either high or low line frequencies and visually integrated settings composed of the other of the high or low line frequencies. When the software/firmware is confronted with a secure document containing both high and low frequency line structures, it cannot correctly assign the lines to discrete filters, so it defaults to one or the other filters, but not both at the same time. If the device (the collection of software/firmware) uses the high pass filter to render the image, then the low frequency line structures in the original document will not be output correctly, resulting in omissions and distortions in the resulting copy. Alternately, if the device (the collection of software/firmware) uses the low pass filter to render the image, then the high frequency line structures in the original document will not be output correctly, resulting in omissions and distortions in the resulting copy. This “filter confusion” can be controlled by constructing original artwork in accordance with the invention.

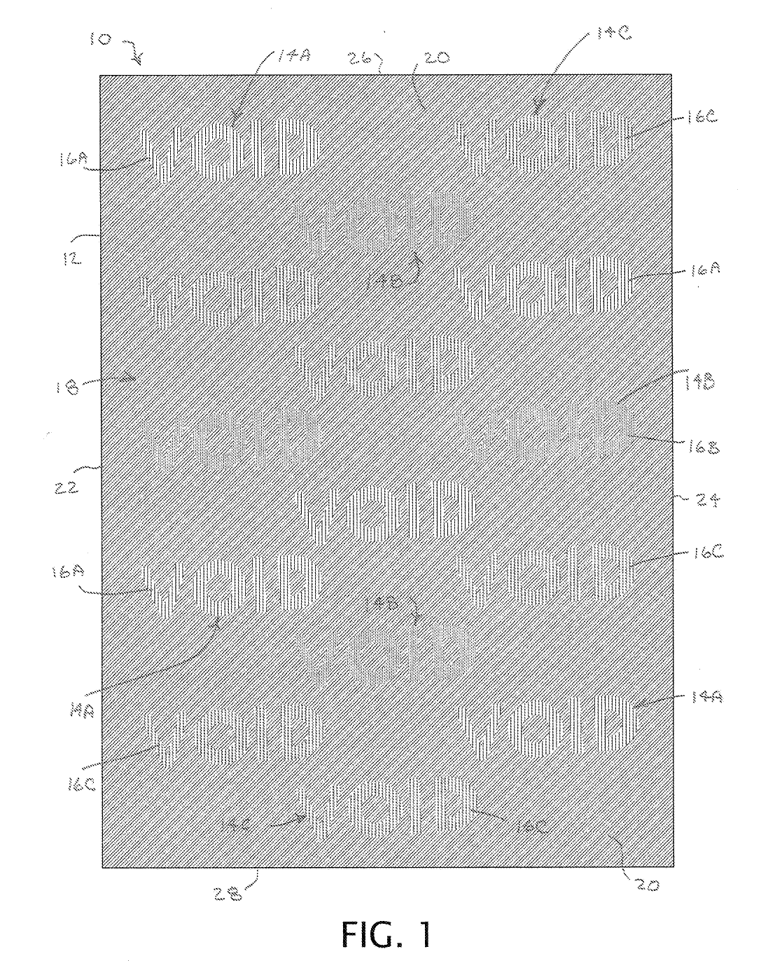

FIG. 1 depicts a print medium in the form of a stock paper document 10 having a substrate 12 that is preprinted with security features. A plurality of latent images 14A-C filled by line-screen patterns 16A-C are embedded within a visually integrated setting 18 filled by a line-screen pattern 20. The latent images 14A-C contain the hidden message “VOID”, which is intended to be substantially indistinguishable from the visually integrated setting 18 to the unaided eye. Despite varying in line frequency, all of the line-screen patterns 16A-C have approximately the same color and print density as the line-screen pattern 20 of the visually integrated setting 18. The line-screen patterns 16A-C are visually matched to the line-screen pattern 20 so that the latent images 14A-C are not readily distinguishable from their visually integrated setting 18 to the unaided eye. The matching colors can also be formed by matching color combinations among the print elements of the line-screen patterns. The latent images 14A-C can also be arranged as a plurality of different messages, as well as other text or graphic forms.

Three different line frequencies are represented among the line-screen patterns 16A-C of the latent images 14A-C. One preferred combination of different line frequencies of the latent images 14A-C includes line frequencies of 75 lines per inch, 90 lines per inch, and 95 lines per inch, together with a line frequency of 180 lines per inch for the visually integrated setting 18. Another preferred combination of different line frequencies of the latent images 14A-C includes line frequencies of 65 lines per inch, 75 lines per inch, and 95 lines per inch, together with a line frequency of 180 lines per inch for the visually integrated setting 18. The different line frequencies of the latent images 14A-C are targeted together with the much higher line frequency of the visually integrated setting 18 to the known performance of known digital reproduction technologies, e.g., known scanners and copiers, so that upon copying the document 10, the hidden message (VOID) of the latent images 14A-C becomes much more clearly visible in the copy.

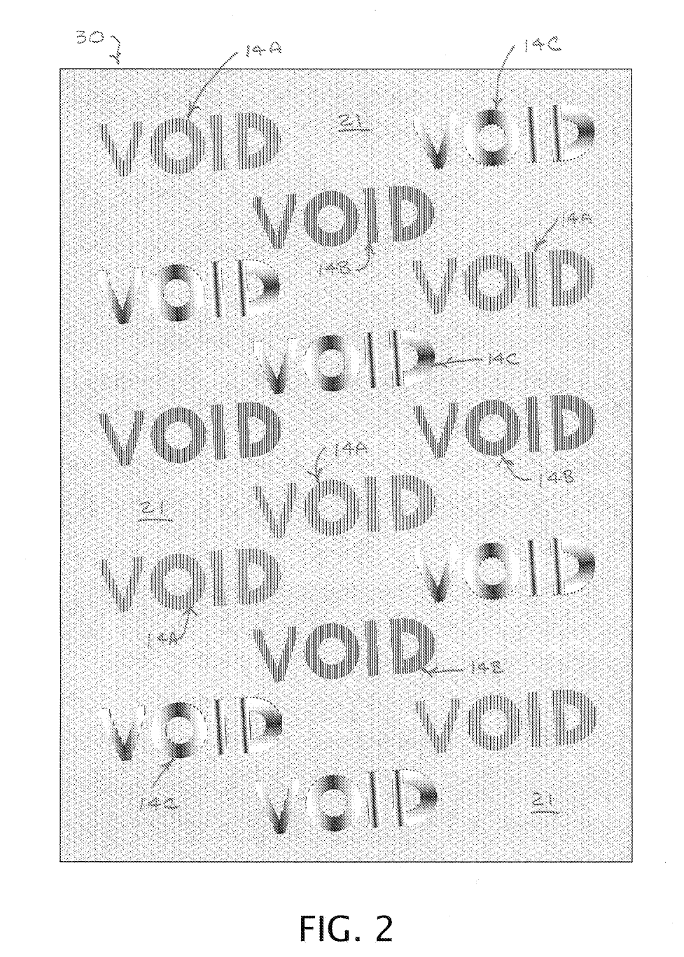

For example, FIG. 2 depicts a digitally reproduced copy 30 of the printed document 10. The line-screen pattern 20 of the visually integrated setting 18 nearly disappears and is replaced by a color-shifted tint 21 that is much lighter (i.e., much lower print density) than the line-screen pattern 20. The patterned lines of the line-screen pattern 20 are not reproduced in their original form and orientation, and the replacement print elements making up the new tone are much more widely dispersed. In addition, the line-screen patterns 16A-C of the latent images 14A-C are all relatively darkened or distorted by interference. The line-screen patterns 14A and 14B are shown darkened, and the line-screen patterns 14C are shown distorted, such as by a moiré effect.

Returning to FIG. 1, it is apparent that the lines of all three line-screen patterns 16A-C of the latent images 14A-C are oriented in a common direction parallel to the sides 22 and 24 of the substrate 12. Since the substrate 12 has a rectangular shape, the sides 22 and 24 of the substrate 12 are orthogonal to the ends 26 and 28 of the substrate 12. Such substrates are generally scanned by relatively advancing the substrate 12 with respect to a sensor array in one of the two orthogonal directions. The lines of the line-screen patterns 16A-C are preferably oriented in one or both of the orthogonal directions, and most preferably in just one of the orthogonal directions as shown.

For printing the line-screen patterns 16A-C by offset printing, the lines of the line-screen patterns 16A-C are preferably oriented in the printing direction to avoid what is known as “waterfall” or “ghosting” effect. For example, line-screen patterns with lines oriented parallel or close to parallel with the print cylinder can attract more ink, especially over the course of a print run. This causes over-inking of these lines, making them appear darker than the lines printed at other angles. If an adjustment is made to compensate for the over-inking of one of the sets of lines, such as decreasing the ink density, then the lines printing at other angles contained in the patterns will also decrease in density. This will cause the images meant to be hidden to “ghost”, or to appear lighter than the surrounding background, defeating the intended hidden nature of the security feature. To improve upon this, all of the latent image lines are preferably printed at 90 degrees to the axis of the print cylinder, and the integrated setting lines are preferably printed at 45 or 135 degrees to the print cylinder axis.

Some “ghosting” and waterfall effects can be reduced by printing the coarser line frequencies at 0 degrees or 90 degrees to the print cylinder axis to reduce the need to balance two different sets of line densities on a print substrate. Utilizing this method, it is much easier to print a sheet that appears “smooth”—where the hidden (latent) images blend in perfectly with the background screen (e.g., the visually integrated setting). This also allows for overall lower ink density (darkness) to be lowered several percentage points, which is desirable when printing certain types of jobs.

The visually integrated setting 18 is depicted as a nondescript background pattern, but in other embodiments, the visually integrated setting can include additional details such as forming together with the latent images 14A-C a composite pattern, such as a picture, portrait, design, or other artwork. The overall print density for both the latent images 14A-C and the visually integrated setting 18 is preferably limited to between approximately 5 percent and 25 percent so that adequate contrast is possible in the digitally reproduced copy. Higher print densities, as defined by the percent of the intended fill areas occupied by the print elements of the line-screen patterns, can impair further use of the stock paper document 10 by decreasing the remaining possible contrast with additional printing or can produce darker tone reproductions of even the higher frequency *e.g., above 120 lines per inch) screen patterns, which could obscure the hidden message intended for copies. However, the overall print density can be progressively or discretely varied over different areas of the substrate, including areas encompassing both the latent images 14A-C and their visually integrated setting 18, to achieve desired visual effects. In doing so, some local print densities may preferably exceed 25 percent.

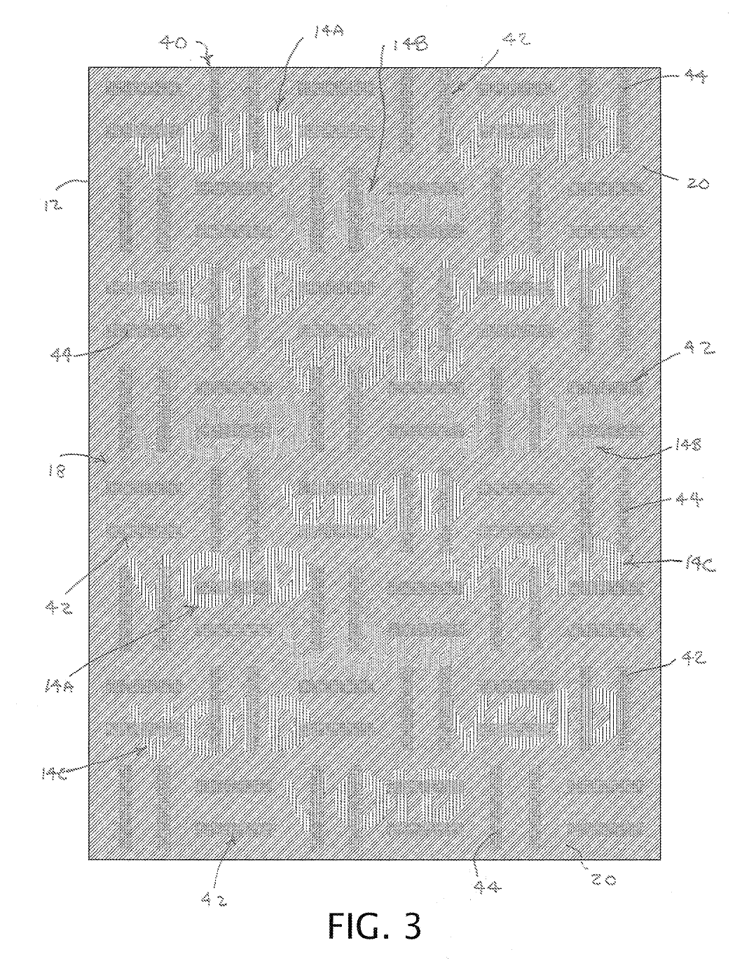

The lower line frequencies of the line-screen patterns 16A-C of the latent images 14A-C, such as the line frequencies of 65 lines per inch and 75 lines per inch are difficult to hide within the much higher line frequencies (e.g., 180 lines per inch) of the visually integrated setting 18. Even at low print densities (e.g., 15 percent), the line elements of the low frequency (e.g., 65 lines per inch) line-screen patterns can be quite wide (e.g., 0.002 inches) and spaced apart through wide gaps (e.g., 0.013 inches). To reduce the visibility of the latent images 14A-C, the invention also contemplates the use of a masking design 42 as shown in the modified stock paper document 40 of FIG. 3. The substrate 12 and other features in common with the embodiment of FIG. 1 are labeled by the same reference characters.

The masking design 42 has a line-screen pattern 44 that fills spatially distributed areas of the substrate 12 to have a balanced effect throughout the stock paper document 40. The line-screen pattern 44 of the masking design overlaps areas in common with both the line-screen patterns 16A-C of the latent images 14A-C and the line-screen pattern 20 of the visually integrated setting 18.

Each of the line-screen patterns 16A-C, 20, and 44 is formed by array of print elements, such as dots, dashes, line segments, or other elemental shapes, in an arrangement of systematically spaced lines. The lines of the line-screen patterns 16A-C and 20 of the latent images 14A-C and the visually integrated setting 18 are preferably formed by print elements arranged as line segments. However, the corresponding lines of the line-screen pattern 44 of the masking design 42 are preferably formed by periodically spaced dots, which can be the same or a different color than the print elements of the other line-screen patterns 16A-C and 20. In addition to masking the latent images 14A-C within the visually integrated setting 18, the line-screen pattern 44 of the masking design can adjust the tint or the tone of the stock paper document 40 or function as a watermark to provide another security feature. The line frequency of the line-screen pattern 44 is preferably approximately equal to or higher than the line frequency of the line-screen pattern 20 so that upon digital reproduction the line-screen pattern 44 fades or otherwise fails to reproduce accurately.

A similar masking design 52 in a more compact form is shown within an enlarged area 50 in the view of FIG. 4. A portion of a latent image 54 filled by a vertically oriented line-screen pattern 56 (also referenced as C) is embedded within a visually integrated setting (e.g., background) 58 filled by a diagonally oriented line-screen pattern 60 (also referenced as A) having a significantly higher line frequency. Preferably, the line frequency of the line-screen pattern 56 of the latent image 54 is well below 120 lines per inch (e.g., 95 lines per inch), and the line frequency of the line-screen pattern 60 of the visually integrated setting 58 is well above 120 lines per inch (e.g., 180 lines per inch).

The masking design 52 includes discrete areas 62 arranged in a repeating pattern and filled with a line-screen pattern 64 (also referenced as B) assembled by arrays of print elements in the form of dots. The print elements (dots) of the masking design line-screen pattern 64 can be seen to overprint in between, around, or on the print element line structures of the line-screen patterns 56 and 60 of the latent image 54 and the visually integrated setting 58.

As an alternative to dots, the print elements of the masking design line-screen pattern 64 can take the form of lines, dashes, or other elemental shapes utilizing one or several colors. The fill areas for the line-screen patterns can be random, repeating, or even continuous and can be printed over or under the line-screen patterns 56 and 60 of the latent image 54 and visually integrated setting 58. When a 140-190 line per inch or higher line frequency is used for the line-screen pattern 64, the masking design 62 tends to lighten, shift, or otherwise disintegrate between 25 percent and 75 percent of the actual printing density when copied or scanned. The above-described high/low pass filtering can also be exploited to assure that the masking design 62 does not inhibit the development of the latent image in digitally reproduced copies.

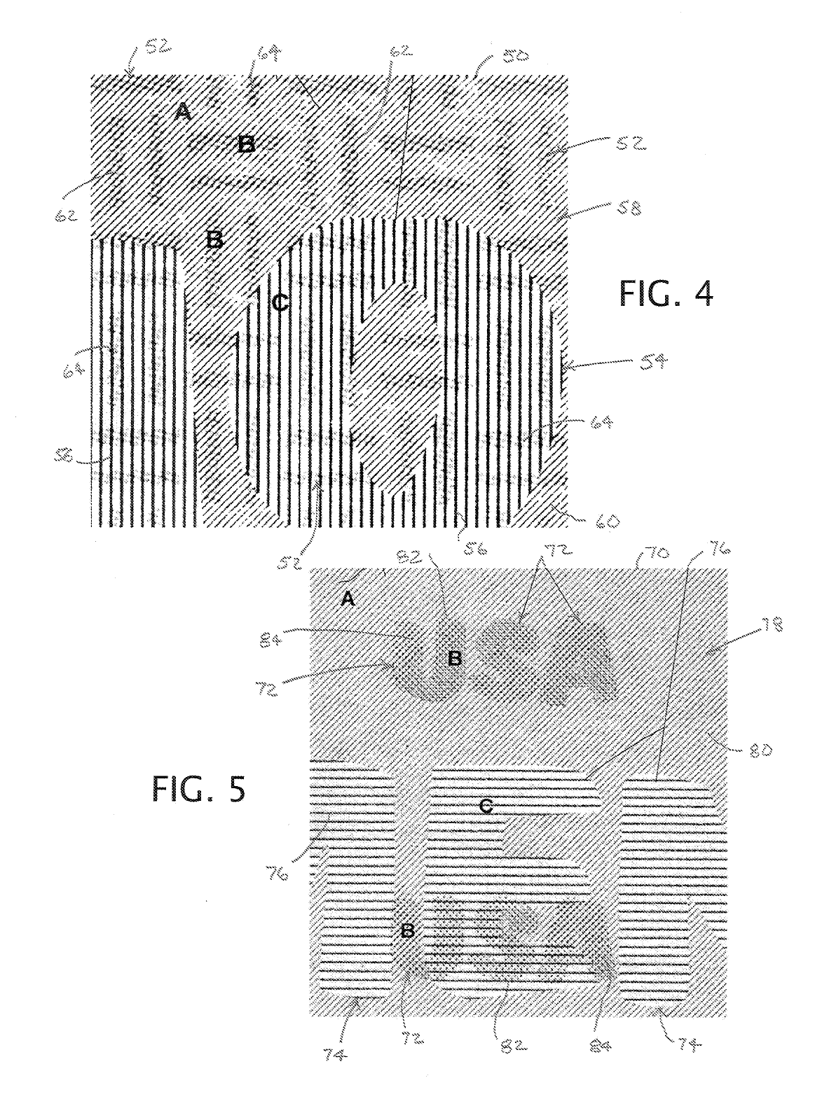

An alternative masking design 72 in the form of characters (USA) is shown within an enlarged area 70 in the view of FIG. 5. A portion of a latent image 74 filled by a horizontally oriented line-screen pattern 76 (also referenced as C) is embedded within a visually integrated setting (e.g., background) 78 filled by a diagonally oriented line-screen pattern 80 (also referenced as A) having a significantly higher line frequency. Similar to the preceding embodiment, the line frequency of the line-screen pattern 76 of the latent image 74 is preferably well below 120 lines per inch (e.g., 95 lines per inch), and the line frequency of the line-screen pattern 80 of the visually integrated setting 78 is preferably well above 120 lines per inch (e.g., 180 lines per inch).

Again, dots are used as the print elements of a masking design line-screen pattern 84 for filling discrete areas 82 (also referenced as B) in the form of characters (USA). The print elements (dots) of the masking design line-screen pattern 84 can be seen to overprint in between, around, or on the print element line structures of the line-screen patterns 76 and 80 of the latent image 74 and the visually integrated setting 78. The line frequency of the masking design line-screen pattern 84 is preferably approximately the same (e.g., 180 lines per inch) or higher than the line frequency of the integrated setting line-screen pattern 80 so that both tend to drop out upon copying for exposing the latent image 74.

In addition to masking differences between the latent image 74 and the visually integrated setting 78, the masking design line-screen pattern 84 can provide a document watermark or alter the tone, tint, or texture of the document. This is preferably accomplished without disturbing the development of the latent image as a robust warning message in digitally reproduced copies.

Although the invention has been particularly described with respect to stock paper documents, the invention is applicable to a vide variety of print media useable for a wide variety of purposes. For example, the print substrates can include, paper, plastic, film, or foil substrates and laminates. The print media itself can be used for a wide range of purposes including personal, commercial, or official use, including identification cards, driver's licenses, currency, and preprinted security paper or in other forms, including product packaging and artwork, such as prints and posters, for thwarting unauthorized copying.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes that come within the meaning and range of equivalency of the claims are therefore intended to be embraced therein.

1. A security enhanced print medium comprising
a print substrate,
a plurality of latent images formed by a plurality of different line-screen patterns printed on distinct areas of the print substrate within a visually integrated setting formed by another different line-screen pattern printed on adjoining areas of the print substrate,
the different line-screen patterns of the latent images and the visually integrated setting matching in color and print density,
the different line-screen patterns of the latent images having a line frequency less than a line frequency of the line-screen pattern of the visually integrated setting, and
the different line-screen patterns of the latent images also having line frequencies differing from one another so that upon reproduction of the print medium through a digital reproduction technology, at least one of the latent images is rendered more readily discernable to the unaided eye.

2. The print medium of claim 1 in which the print substrate has a rectangular form with orthogonal axes extending along adjacent sides of the print substrate, and the different line-screen patterns of the latent images are aligned with at least one of the orthogonal axes.

3. The print medium of claim 2 in which the line-screen pattern of the visually integrated setting is inclined at an acute angle to both orthogonal axes.

4. The print medium of claim 3 in which the line-screen pattern of the visually integrated setting is inclined at an angle of approximately 45 degrees to both orthogonal axes.

5. The print medium of claim 3 in which the different line-screen patterns of the latent images are aligned with just one of the orthogonal axes.

6. The print medium of claim 1 in which the line-screen patterns of the latent images have line frequencies below 120 lines per inch and the line-screen pattern of the visually integrated setting has a line frequency above 120 lines per inch.

7. The print medium of claim 6 in which the line-screen pattern of the visually integrated setting has a line frequency of approximately 180 lines per inch.

8. The print medium of claim 6 in which the line-screen patterns of the latent images include one line frequency of approximately 75 lines per inch and another line frequency of approximately 95 lines per inch.

9. The print medium of claim 8 in which in which another of the latent image line-screen patterns has a line frequency of approximately 90 lines per inch.

10. The print medium of claim 8 in which in which another of the latent image line-screen patterns has a line frequency of approximately 65 lines per inch.

11. The print medium of claim 1 in which the matching print density of the latent images and the visually integrated setting is between 5 percent and 25 percent.

12. The print medium of claim 1 further comprising a masking design having a line-screen pattern that overlaps with the line-screen patterns of both the latent images and the visually integrated setting over common areas of the print substrate.

13. The print medium of claim 12 in which the line-screen pattern of the masking design is oriented at an angle that differs from angular orientations of the line-screen patterns of both the latent images and the visually integrated setting.

14. The print medium of claim 12 in which the masking design is evenly spatially distributed over the printed areas of the print substrate.

15. The print medium of claim 14 in which the latent images are evenly spatially distributed over the printed areas of the print substrate.

16. The print medium of claim 12 in which the line-screen patterns of the latent image, the visually integrated setting, and the masking design are formed by arrays of print elements in arrangements of systematically spaced lines.

17. The print medium of claim 16 in which the print elements that form the masking design line-screen pattern differ from the print elements that form the visually integrated setting line-screen pattern.

18. The print medium of claim 17 in which the print elements that form the masking design line-screen pattern also differ from the print elements that form the latent image line-screen patterns.

19. The print medium of claim 17 in which the print elements that form the masking design line-screen pattern are spaced apart along the systematically spaced lines of the line-screen pattern.

20. The print medium of claim 17 in which the print elements that form the masking design line-screen pattern are a different color than the print elements that form the line-screen patterns of the latent images and the visually integrated setting.

21. The print medium of claim 12 in which the line-screen pattern of the masking design has a line frequency at least approximately as high as the line frequency of the visually integrated setting line-screen pattern.

22. A method of making a security enhanced print medium comprising steps of
printing a plurality of latent images within a visually integrated setting on a print substrate using line-screen patterns that match in color and print density so that the latent images are not readily distinguishable from the visually integrated setting to the naked eye,
arranging the latent images with line-screen patterns having line frequencies that differ from each other and from a line frequency of the line-screen pattern of the visually integrated setting, and
setting each of the different line frequencies of the latent image line-screen patterns to react preferentially with a different digital reproduction technology for relatively increasing the latent images in tone with respect to the visually integrated setting upon reproduction by the digital reproduction technologies.

23. The method of claim 22 including a step of setting the line frequency of the visually integrated setting to react with one or more of the different digital reproduction technologies so that the visually integrated setting reduces in tone upon digital reproduction.

24. The method of claim 23 in which the step of setting each of the different line frequencies of the latent image line-screen patterns includes setting the different line frequencies to values of approximately 75 lines per inch and 95 lines per inch.

25. The method of claim 24 in which the step of setting the line frequency of the visually integrated setting includes setting the line frequency to a value of approximately 180 lines per inch.

26. The method of claim 24 in which the step of setting each of the different line frequencies of the latent image line-screen patterns also includes setting the different line frequencies to at least one of 65 lines per inch and 90 lines per inch.

27. The method of claim 26 including a step of orienting the line-screen patterns includes orienting the line-screen patterns of the latent images having different line frequencies in a common direction.

28. The method of claim 22 including a step of orienting the line-screen patterns of the latent images having different line frequencies orthogonal to one or more edges of the print substrate.

29. The method of claim 27 including a step of orienting the line-screen pattern of the visually integrated setting at an acute angle to the one or more edges of the print substrate.

30. The method of claim 22 including a step of orienting the line-screen patterns includes orienting the line-screen patterns of the latent images having different line frequencies in a common direction.

31. The method of claim 22 including a step of printing a masking design on the print substrate with a line-screen pattern that overlaps with the line-screen patterns of both the latent images and the visually integrated setting.

32. The method of claim 31 including a step of orienting the line-screen pattern of the masking design at an angle that differs from angular orientations of the line-screen patterns of both the latent images and the visually integrated setting.

33. The method of claim 31 in which steps of printing include printing the line-screen patterns as arrays of print elements in arrangements of systematically spaced lines, and the print elements of the masking design differ from the print elements of both the latent images and the visually integrated setting.

34. The method of claim 33 in which the step of printing the masking design includes printing the print elements that form the masking design line-screen pattern in positions that are spaced apart along the systematically spaced lines of the line-screen pattern.

35. The method of claim 33 in which the step of printing the masking design includes printing the print elements that form the masking design line-screen pattern in a different color than the print elements of both the latent images and the visually integrated setting.

36. The method of claim 31 in which the step of printing a masking design includes printing the line-screen pattern of the masking design at a line frequency at least approximately as high as the line frequency of the visually integrated setting line-screen pattern.

37. A camouflaged security enhanced print medium comprising
a print substrate,
a plurality of latent images formed by a plurality of different line-screen patterns printed on distinct areas of the print substrate within a visually integrated setting formed by another different line-screen pattern printed on adjoining areas of the print substrate,
the different line-screen patterns of the latent images and the visually integrated setting matching in color and print density so that the latent images are not readily discernable to an unaided eye, and
a masking design formed by a line-screen pattern printed on both the distinct areas of the print substrate and the adjoining areas of the print substrate for further obscuring differences between the latent images and the visually integrated setting.

38. The print medium of claim 37 in which the line-screen pattern of the masking design is oriented at an angle that differs from angular orientations of the line-screen patterns of both the latent images and the visually integrated setting.

39. The print medium of claim 37 in which the masking design is evenly spatially distributed over the printed areas of the print substrate.

40. The print medium of claim 39 in which the latent images are also evenly spatially distributed over the printed areas of the print substrate.

41. The print medium of claim 37 in which the line-screen patterns of the latent image, the visually integrated setting, and the masking design are formed by arrays of print elements in arrangements of systematically spaced lines.

42. The print medium of claim 37 in which the print elements that form the masking design line-screen pattern differ from the print elements that form the visually integrated setting line-screen pattern.

43. The print medium of claim 42 in which the print elements that form the masking design line-screen pattern also differ from the print elements that form the latent image line-screen patterns.

44. The print medium of claim 42 in which the print elements that form the masking design line-screen pattern are spaced apart along the systematically spaced lines of the line-screen pattern.

45. The print medium of claim 42 in which the print elements that form the masking design line-screen pattern are a different color than the print elements that form the line-screen patterns of the latent images and the visually integrated setting.

46. The print medium of claim 37 in which the different line-screen patterns of the latent images have a line frequency less than a line frequency of the line-screen pattern of the visually integrated setting, and the different line-screen patterns of the latent images also have line frequencies differing from one another so that upon reproduction of the print medium through a digital reproduction technology, at least one of the latent images is rendered more discernable to the unaided eye.

47. The print medium of claim 37 in which the line-screen pattern of the masking design has a line frequency at least approximately as high as the line frequency of the visually integrated setting line-screen pattern.
